(19) United States
(12) Patent Application Publication
(10) Pub. No.: US 2013/0050446 A1
(43) Pub. Date: Feb. 28, 2013

(54) OBJECT SEARCH DEVICE, VIDEO DISPLAY DEVICE, AND OBJECT SEARCH METHOD

(71) Applicant: Kaoru Matsuoka, Tokyo (JP)

(72) Inventor: Kaoru Matsuoka, Tokyo (JP)

(73) Assignee: Kabushiki Kaisha Toshiba, Tokyo (JP)

(21) Appl. No.: 13/468,746

(22) Filed: May 10, 2012

(30) Foreign Application Priority Data
Aug. 31, 2011 (JP) 2011-189531

(51) Int. Cl. G06K 9/62; H04N 13/04

(52) U.S. Cl. 348/51; 382/103; 348/E13.026

(57) ABSTRACT

An object search device has a search area setting unit configured to sequentially set each of a plurality of divisional frame areas as a search area, an object searching unit configured to search an object included in the divisional frame area set as the search area, and detect a coordinate position of the searched object, an object tracking unit configured to perform motion detection by comparing a previous screen frame with a current screen frame based on the coordinate position of the object searched by the object searching unit, and detect the coordinate position of the object in the current screen frame, and a coordinate synthesizer configured to compare the coordinate position of the object searched by the object searching unit with the coordinate position of the object tracked by the object tracking unit.

### CROSS REFERENCE TO RELATED APPLICATIONS

This application is based upon and claims the benefit of priority from the prior Japanese Patent Application No. 2011-189531, filed on Aug. 31, 2011, the entire contents of which are incorporated herein by reference.

### FIELD

Embodiments of the present invention relate to an object search device for searching an object in a screen frame, a video display device, and an object search method.

### BACKGROUND

A technique for searching an object included in a screen frame and performing motion compensation by detecting the moving direction of the searched object has been suggested.

However, in order to search an object in the screen frame, it is required to analyze the characteristics of the image over the entire screen frame using a certain technique, or to search the motion of the object by comparing adjacent screen frames. Such an object search process should be performed with respect to each screen frame, which leads to a problem of increasing processing time.

Recently, a three-dimensional TV capable of displaying a stereoscopic video has been rapidly popularized, but three-dimensional video data is not widely available as a video source due to the compatibility with existing TV and its price. Accordingly, in many cases, the three-dimensional TV performs a process of converting existing two-dimensional video data into pseudo three-dimensional video data. In this case, it is required to search a characteristic object in each screen frame of the two-dimensional video data and to add depth information thereto. However, it takes much time for the object search process as stated above, and thus there may be a case where much time is not available to generate depth information with respect to each screen frame.

### BRIEF DESCRIPTION OF THE DRAWINGS

FIG. 1 is a block diagram showing a schematic structure of a video display device 2 according to the present embodiment.

FIG. 2 is a detailed block diagram of a depth information generator 8 and a three-dimensional data generator 9 according to one embodiment.

FIG. 3 is a flow chart showing an example of the processing operation performed by an object search device 1 of FIG. 1.

FIG. 4 is a diagram schematically explaining the process performed by the object search device 1 of FIG. 1.

FIG. 5 is a diagram explaining the width of one divisional frame area.

FIG. 6 is a flow chart showing a detailed processing operation performed by a coordinate synthesizer 6.

FIG. 7 is a diagram explaining the process performed by the coordinate synthesizer 6.

### DETAILED DESCRIPTION

An object search device has a search area setting unit configured to sequentially set each of a plurality of divisional frame areas as a search area, the divisional frame areas being obtained by dividing a screen frame into a plurality of areas, an object searching unit configured to search an object included in the divisional frame area set as the search area, and detect a coordinate position of the searched object, an object tracking unit configured to perform motion detection by comparing a previous screen frame with a current screen frame based on the coordinate position of the object searched by the object searching unit, and detect the coordinate position of the object in the current screen frame, and a coordinate synthesizer configured to compare the coordinate position of the object searched by the object searching unit with the coordinate position of the object tracked by the object tracking unit, and specify the coordinate position of the object by cutting one of a pair of overlapping coordinate positions.

Embodiments will now be explained with reference to the accompanying drawings.

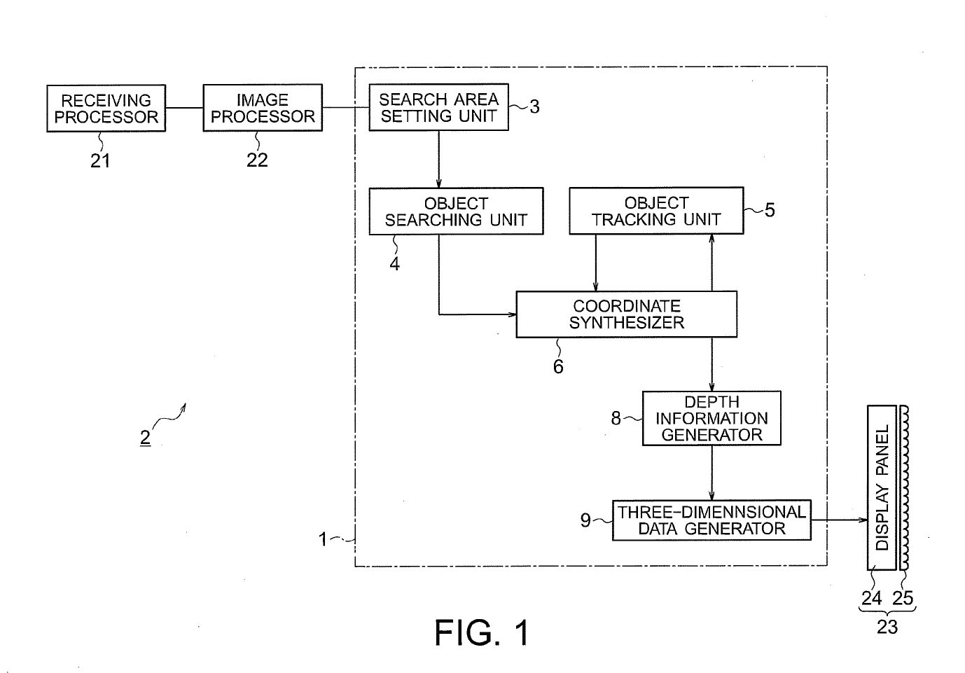

FIG. 1 is a block diagram showing a schematic structure of a video display device 2 having an object search device 1 according to the present embodiment. First, the internal structure of the object search device 1 will be explained.

The object search device 1 of FIG. 1 has a search area setting unit 3, an object searching unit 4, an object tracking unit 5, a coordinate synthesizer 6, a depth information generator 8, and a three-dimensional data generator 9.

The search area setting unit 3 sequentially sets each of a plurality of divisional frame areas obtained by dividing one screen frame into a plurality of areas as a search area one by one. More concretely, the search area setting unit 3 assigns an identification number to each of the divisional frame areas, and sets one arbitrary divisional frame area as a search area by specifying any one of the identification numbers.

Note that the screen frame may be divided into a plurality of areas in the horizontal direction or in the vertical direction. The following explanation is based on an example where the screen frame is divided in the horizontal direction.

The object searching unit 4 searches an object included in a divisional frame area set as the search area, and detects the coordinate position of the searched object. Since the object searching unit 4 searches an object only included in one divisional frame area of the screen frame, not in the entire screen frame, time required for the search process can be shortened.

The object tracking unit 5 performs motion detection by comparing a current screen frame with a previous screen frame based on the coordinate position of the object detected by the object searching unit 4, to detect the coordinate position of the object in the current screen frame. More specifically, the object tracking unit 5 performs motion detection by comparing the current screen frame with the previous screen frame with respect to the area including the coordinate position of the object detected by the object searching unit 4. When moving direction and moving amount (motion vector) are detected as a result, the coordinate position of the object detected by the object searching unit 4 is corrected by a motion vector, and the coordinate position of the object in the current screen frame is detected.

The coordinate synthesizer 6 compares the coordinate position of the object detected by the object searching unit 4 with the coordinate position of the object detected by the object tracking unit 5, and cuts one of a pair of overlapping coordinate positions. In this case, when the number of coordinate position of the object detected by the object searching unit 4 is M (M is an integer of 1 or greater) and the number of coordinate position of the object detected by the object tracking unit 5 is N (N is an integer of 1 or greater), these (M+N) number of coordinate positions are compared with each other in a round-robin style, and one of each pair of overlapping coordinate positions is cut. When a coordinate position of the object detected by the object searching unit 4 and a coordinate position of the object detected by the object tracking unit 5 overlap each other, the coordinate position of the object detected by the object tracking unit 5 is cut. This is because the coordinate position of the object detected by the object searching unit 4 is more reliable. The coordinate position of the object is specified by the process performed by the coordinate synthesizer 6.

The depth information generator 8 generates depth information corresponding to the object detected by the coordinate synthesizer 6. Then, the three-dimensional data generator 9 generates three-dimensional video data of the object, based on the object detected by the coordinate synthesizer 6 and its depth information. The three-dimensional video data includes right-eye parallax data and left-eye parallax data, and may include multi-parallax data depending on the situation.

The depth information generator 8 and the three-dimensional data generator 9 are not necessarily essential. When there is no need to record or reproduce three-dimensional video data, the depth information generator 8 and the three-dimensional data generator 9 may be omitted.

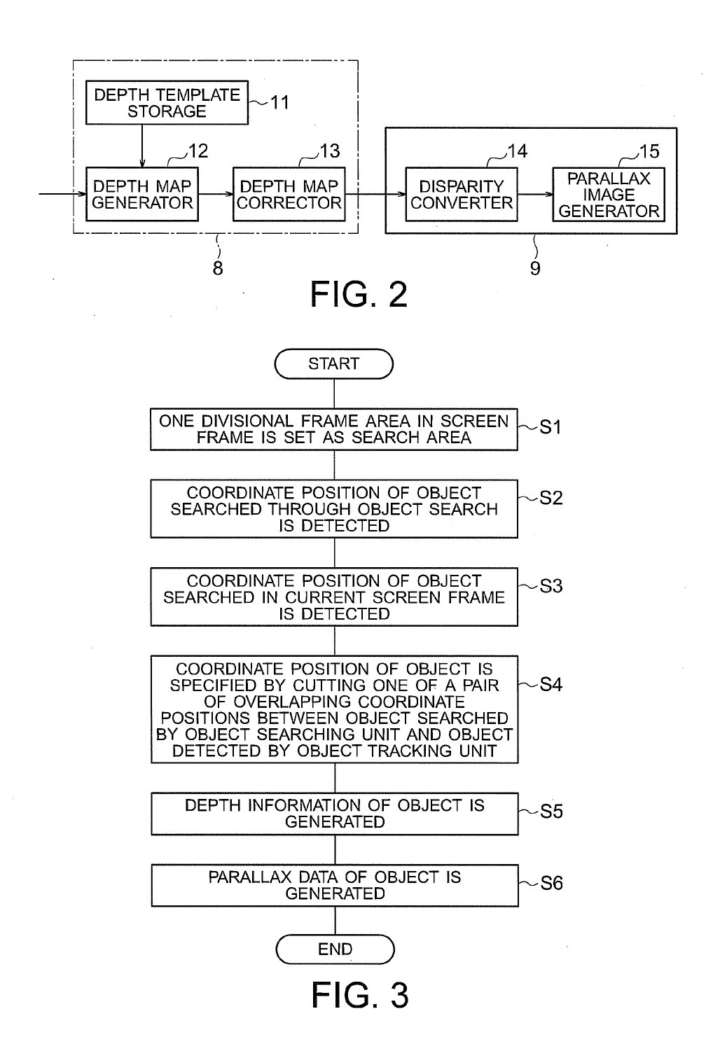

FIG. 2 is a detailed block diagram of the depth information generator 8 and the three-dimensional data generator 9. As shown in FIG. 2, the depth information generator 8 has a depth template storage 11, a depth map generator 12, and a depth map corrector 13. The three-dimensional data generator 9 has a disparity converter 14 and a parallax image generator 15.

The depth template storage 11 stores a depth template describing the depth value of each pixel of each object, corresponding to the type of each object.

The depth map generator 12 reads, from the depth template storage 11, the depth template corresponding to the object detected by the coordinate synthesizer 6, and generates a depth map relating depth value to each pixel of frame video data supplied from an image processor 22.

The depth map corrector 13 corrects the depth value of each pixel by performing weighted smoothing on each pixel on the depth map using its peripheral pixels.

The disparity converter 14 in the three-dimensional data generator 9 generates a disparity map describing the disparity vector of each pixel by obtaining the disparity vector of each pixel from the depth value of each pixel in the depth map. The parallax image generator 15 generates a parallax image using an input image and the disparity map.

The video display device 2 of FIG. 1 is a three-dimensional TV for example, and has a receiving processor 21, the image processor 22, and a three-dimensional display device 23, in addition to the object search device 1 of FIG. 1.

The receiving processor 21 demodulates a broadcast signal received by an antenna (not shown) to a baseband signal, and performs a decoding process thereon. The image processor 22 performs a denoising process etc. on the signal passed through the receiving processor 21, and generates frame video data to be supplied to the object search device 1 of FIG. 1.

The three-dimensional display device 23 has a display panel 24 having pixels arranged in a matrix, and a light ray controlling element 25 having a plurality of exit pupils arranged to face the display panel 24 to control the light rays from each pixel. The display panel 24 can be formed as a liquid crystal panel, a plasma display panel, or an EL (Electro Luminescent) panel, for example. The light ray controlling element 25 is generally called a parallax barrier, and each exit pupil of the light ray controlling element 25 controls light rays so that different images can be seen from different angles in the same position. Concretely, a slit plate having a plurality of slits or a lenticular sheet (cylindrical lens array) is used to create only right-left parallax (horizontal parallax), and a pinhole array or a lens array is used to further create up-down parallax (vertical parallax). That is, each exit pupil is a slit of the slit plate, a cylindrical lens of the cylindrical lens array, a pinhole of the pinhole array, or a lens of the lens array serves.

Although the three-dimensional display device 23 according to the present embodiment has the light ray controlling element 25 having a plurality of exit pupils, a transmissive liquid crystal display etc. may be used as the three-dimensional display device 23 to electronically generate the parallax barrier and electronically and variably control the form and position of the barrier pattern. That is, a concrete structure of the three-dimensional display device 23 is not questioned as long as the display device can display an image for stereoscopic image display (to be explained later).

Further, the object search device 1 according to the present embodiment is not necessarily incorporated into TV. For example, the object search device 1 may be applied to a recording device which converts the frame video data included in the broadcast signal received by the receiving processor 21 into three-dimensional video data and records it in an HDD (hard disk drive), optical disk (e.g., Blu-ray Disc), etc.

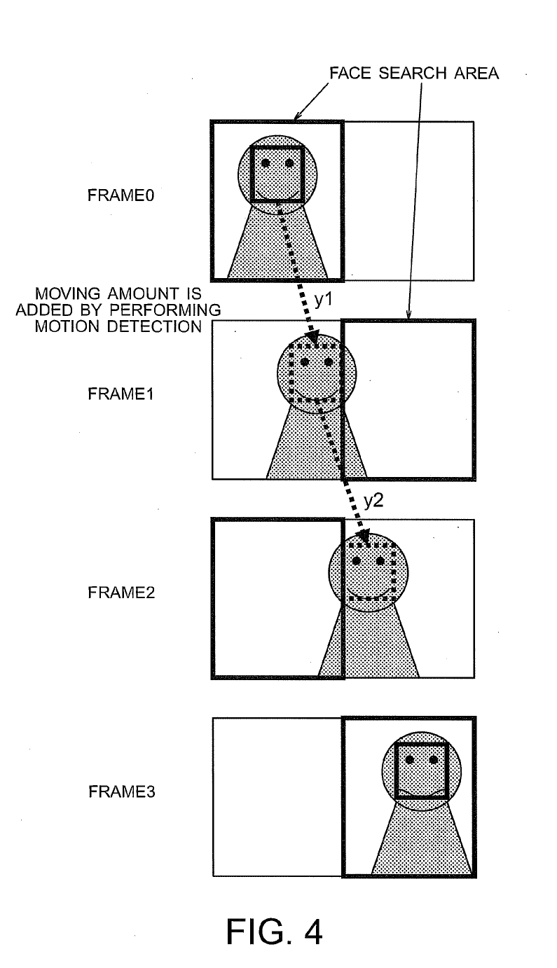

FIG. 3 is a flow chart showing an example of the processing operation performed by the object search device 1 of FIG. 1, and FIG. 4 is a diagram schematically explaining the process performed by the object search device 1 of FIG. 1. In the example of FIG. 4, two divisional frame areas are generated by dividing a screen frame into two in the horizontal direction. Hereinafter, processing operation in the present embodiment will be explained using FIG. 3 and FIG. 4.

First, the search area setting unit 3 sets one divisional frame area in the screen frame as a search area in which object search should be performed (Step S1). More concretely, the search area setting unit 3 gives the identification number corresponding to a specific divisional frame area to the object searching unit 4.

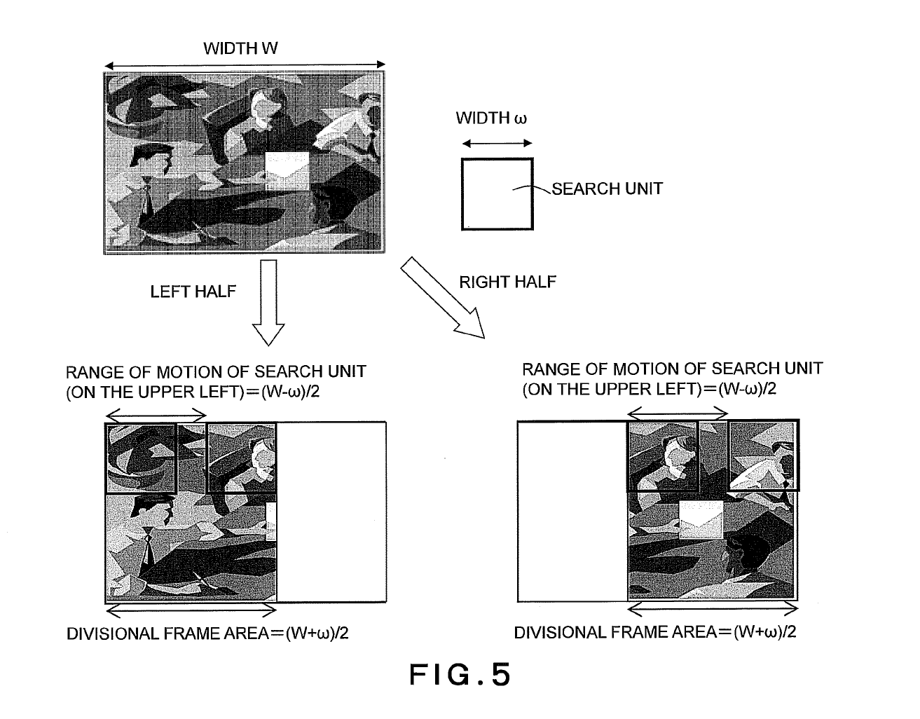

Here, adjacent divisional frame areas are partially overlap each other. FIG. 5 is a diagram explaining the width of one divisional frame area when the screen frame is divided into two divisional frame areas. In the example of FIG. 5, the horizontal width of the screen frame is defined as W, and the horizontal width of a search unit for searching the object is defined as ω. In this case, the horizontal width of the divisional frame area can be expressed as (W+ω)/2. That is, adjacent divisional frame areas overlap each other by the width ω.

By arranging such an overlapping area, all of the objects including an object existing near the boundary of the divisional frame area can be correctly detected in the entire screen frame.

The object searching unit 4 searches an object in the divisional frame area set in Step S1, and detects the coordinate position of the searched object (Step S2). In the example of FIG. 4, as a process for Frame 0, object detection is performed in a left half divisional frame area first. Here, a human face is the object to be searched.

When searching a human face, an object detection method using e.g., Haar-like features is utilized. This object detection method uses a plurality of identification devices connected in series and each identification device has a function of identifying a human face based on the statistical learning previously performed. The identification performance increases as the number of connected identification devices increases, but processing time and implementation area for the identification devices also increase. Therefore, it is desirable that the number of connected identification devices is determined considering acceptable implementation scale and identification accuracy.

When using the Haar-like features, a small search area is set in the divisional frame area, and an object in the search area is detected by shifting this search area in the divisional frame area. For example, when detecting a human face, the search area including both eyes, nose, and upper lip is judged to have a human face. Note that another algorithm may be added so that human profile can be further detected.

Next, the object tracking unit 5 performs motion detection by comparing a current screen frame with a previous screen frame based on the area including the coordinate position of the detected object, to detect the coordinate position of the object in the current screen frame (Step S3).

Note that the processes of the above Steps S1 and S2 are performed in parallel with the process of Step S3. That is, when the object search process is completed in one divisional frame area, the search area setting unit 3 sets the next divisional frame area and the object searching unit 4 performs object search in the newly set divisional frame area, while the object tracking process is simultaneously performed on the object searched through the object search process.

Hereinafter, the process of Step S3 will be explained in detail using FIG. 4. In the example of FIG. 4, when Frame 1 is the current screen frame, the object tracking unit performs motion detection by comparing the previous frame 0 with the current frame 1. In FIG. 4, the area including an object searched in the left divisional frame area of Frame 0 is shown by a rectangle with thick line. In Step S3, the motion of this rectangular area is detected. In Frame 1 serving as the current screen frame, the search area setting unit 3 sets the right divisional frame area, but the object tracking unit 5 detects the motion of the rectangular area over the entire screen frame. As a result, it is detected that the object moves to the dotted line area in the left divisional frame area. In FIG. 4, directional line y1 shows a motion vector.

When the motion vector is obtained, the coordinate position of the object in the current screen frame can be detected by adding a differential coordinate corresponding to the motion vector to the coordinate position of the object detected in Step S3.

Next, the coordinate synthesizer 6 compares the coordinate position of the object detected by the object searching unit 4 with the coordinate position of the object detected by the object tracking unit 5, and specifies the coordinate position of the object by cutting one of a pair of overlapping coordinate positions (Step S4). The coordinate synthesizer 6 compares M number of coordinates of the objects detected by the object searching unit 4 with N number of coordinates of the objects detected and tracked by the object tracking unit 5 in a round-robin style, and specifies the coordinate of each object by cutting one of each pair of overlapping coordinates. More concretely, the coordinate synthesizer 6 performs comparison among M number of detected coordinates, between any one of M number of detected coordinates and any one of N number of tracked coordinates, and among N number of tracked coordinates. The process performed by the coordinate synthesizer 6 will be explained in detail later.

In the example of FIG. 4, the object exists in the left divisional frame area in both of Frame 0 and Frame 1. In the example of Frame 1, no object is searched since the object searching unit 4 performs object search in the right divisional frame area. On the other hand, the object tracking unit 5 detects the motion of the search area of the object searched in Frame 0 over the entire screen frame, and thus can correctly detects that the object moves to the dotted line area.

In Frame 1, the object searching unit 4 cannot search the object, and thus the coordinate synthesizer 6 judges that there is no overlapping coordinate positions.

Next, in frame 2, the object searching unit 4 performs object search in the left divisional frame area, but no object can be searched since the object has already moved to the right side. On the other hand, the object tracking unit 5 can correctly detect the object which has moved to the right divisional frame area, and the coordinate position of the object in Frame 1 can be detected. Also in Frame 1, the object searching unit 4 cannot search the object, and thus the coordinate synthesizer 6 judges that there is no overlapping coordinate positions.

Next, in Frame 3, the object searching unit 4 performs object search in the right divisional frame area. As a result, the object can be searched in the right divisional frame area, and the newest coordinate position of the object is detected. On the other hand, the object tracking unit 5 similarly detects the motion of the object, and detects the current coordinate position of the object. The coordinate synthesizer 6 recognizes that the coordinate positions of the same object is doubly detected by both of the object searching unit 4 and the object tracking unit 5, and cuts the coordinate position detected by the object tracking unit 5 so that the coordinate position detected by the object searching unit 4 is employed for this object.

In the example of FIG. 4, only one object exists in the screen frame. On the other hand, when a plurality of objects exist in the screen frame, the processes of the object tracking unit 5 and the coordinate synthesizer 6 are performed on each of the detected object, and final coordinate positions of the objects are detected.

When the processes of the above Steps S1 to S4 are performed with respect to each frame and the coordinate position of each object is detected, the depth information generator 8 generates depth information of each object (Step S5).

After that, the three-dimensional data generator 9 generates parallax data of each object with respect to each frame (Step S6).

Hereinafter, the process performed by the coordinate synthesizer 6 will be explained in detail. As stated above, the object searching unit 4 performs object search only in a divisional frame area, which is a part of the screen frame. On the other hand, the object tracking unit 5 tracks the object over the entire area of the screen frame. Accordingly, the object searched by the object searching unit 4 and the object tracked by the object tracking unit 5 may be the same or different, depending on the situation. When the same object is doubly searched and tracked by the object searching unit 4 and the object tracking unit 5, the searched and tracked objects should be integrated into one.

Accordingly, the coordinate synthesizer 6 judges whether the object searched by the object searching unit 4 and the object tracked by the object tracking unit 5 are the same, and cuts one of a pair of overlapping coordinates when those objects are the same.

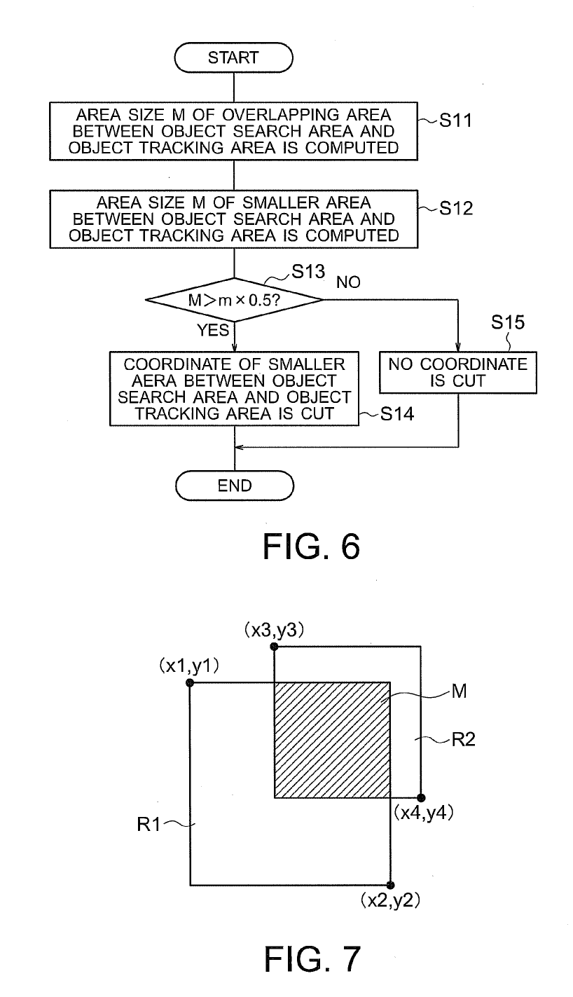

FIG. 6 is a flow chart showing a detailed processing operation performed by the coordinate synthesizer 6, and FIG. 7 is a diagram explaining the process performed by the coordinate synthesizer 6. The coordinate synthesizer 6 computes area size M of the overlapping area between the area including the object searched by the object searching unit 4 (object search area) and the area including the object detected by the object tracking unit 5 (object tracking area) (Step S11).

In FIG. 7, the object search area is a rectangular area R1 having coordinate (x1, y1) and coordinate (x2, y2) arranged on a diagonal line, and the object tracking area is a rectangular area R2 having coordinate (x3, y3) and coordinate (x4, y4) arranged on a diagonal line.

In this case, in FIG. 7, the area size M of the overlapping area between the object search area and the object tracking area can be expressed by the following Formula (I).

M={x2−x1+x4−x3+max(x2,x4)−min(x1,x3)}×{y2−y1+y4−y3+max(y2,y4)−min(y1,y3)} (1)

In the above Formula (I), max(x2, x4) shows a larger value between x2 and x4, and min(x1, x3) shows a smaller value between x1 and x3.

Next, area size m of a smaller area between the object search area and the object tracking area is computed (Step S12).

m=min((x2−x1)×(y2−y1),(x4−x3)×(y4−y3)) (2)

Next, it is judged whether M>m×0.5 is established (Step S13). That is, judgment is given on whether the overlapping area size M is larger than a half of the area size m of the smaller area.

If M>m×0.5, it is judged that the object search area and the object tracking area overlap each other, and the coordinate of a smaller area between the object search area and the object tracking area is cut (Step S14). On the other hand, if M≦m×0.5 in Step S13, it is judged that the areas do not overlap each other, and no coordinate is cut (Step S15).

As stated above, when it is assumed that the object searching unit 4 searches the same object as the object tracked by the object tracking unit 5, the coordinate synthesizer 6 cuts any one of the coordinate of the object tracked by the object tracking unit 5 and the coordinate of the object searched by the object searching unit 4. Accordingly, the object searching unit 4 and the object tracking unit 5 do not simultaneously detect the same object.

As stated above, in the present embodiment, object search is performed only in each divisional frame area of each frame, instead of performing object search over the entire screen frame. Since the divisional frame area going through object search is sequentially switched with respect to each frame, object search is performed on the entire screen frame using a plurality of frames. In each frame, object search is performed only in the divisional frame area, and thus the object search process can be performed at high speed.

However, in this configuration, object search can be performed only in a partial area of each frame, and thus the process of detecting the motion of the object once searched is simultaneously performed in compensation for this demerit. Accordingly, the motion of the object once searched can be correctly detected even when the object moves to the outside of the object search area.

As stated above, according to the present embodiment, object search can be performed with small amount of instructions while detecting the motion of the object, which makes it possible to perform the object search process at high speed and to easily perform the process of detecting the depth information of each object to generate three-dimensional data.

At least a part of the object search device 1 and video display device 2 explained in the above embodiments may be implemented by hardware or software. In the case of software, a program realizing at least a partial function of the object search device 1 and video display device 2 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the object search device 1 and video display device 2 can be distributed through a communication line (including radio communication) such as the Internet. Furthermore, this program may be encrypted, modulated, and compressed to be distributed through a wired line or a radio link such as the Internet or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An object search device, comprising:
a search area setting unit configured to sequentially set each of a plurality of divisional frame areas as a search area, the divisional frame areas being obtained by dividing a screen frame into a plurality of areas;
an object searching unit configured to search an object included in the divisional frame area set as the search area, and detect a coordinate position of the searched object;
an object tracking unit configured to perform motion detection by comparing a previous screen frame with a current screen frame based on the coordinate position of the object searched by the object searching unit, and detect the coordinate position of the object in the current screen frame; and
a coordinate synthesizer configured to compare the coordinate position of the object searched by the object searching unit with the coordinate position of the object tracked by the object tracking unit, and specify the coordinate position of the object by cutting one of a pair of overlapping coordinate positions.

2. The object search device of claim 1,
wherein when the pair of overlapping coordinate positions is detected, the coordinate synthesizer cuts the coordinate position of the object tracked by the object tracking unit.

3. The object search device of claim 1,
wherein the coordinate synthesizer comprises:
an overlapping area detector configured to detect an overlapping area between two objects overlapping each other at least partially;
an area ratio judging unit configured to determine whether one object having a smaller area in the overlapping two objects occupies an area which is equal to or greater than a predetermined ratio of the overlapping area; and
an object cutting unit configured to cut the coordinate position of the object having the smaller area when the area ratio judging unit determines that the object having the smaller area occupies the area which is equal to or greater than the predetermined ratio.

4. The object search device of claim 1,
wherein the search area setting unit sets the divisional frame areas so that adjacent two divisional frame areas partially overlap each other.

5. The object search device of claim 1,
wherein processes performed by the object searching unit, the object tracking unit, and the coordinate synthesizer are repeated until the search area setting unit sets all of the divisional frame areas sequentially.

6. The object search device of claim 1,
wherein the object is a human face.

7. The object search device of claim 1, further comprising:
a depth information generator configured to generate depth information of the object having the coordinate position specified by the coordinate synthesizer; and
a three-dimensional data generator configured to generate parallax data for displaying the object in three dimension, based on the depth information generated by the depth information generator.

8. A video display device, comprising:
a receiving processor configured to receive a broadcast wave, and perform a decoding process and a predetermined image processing thereon to generate frame video data;
a display device configured to display the parallax data; and
an object search device,
the object search device comprising:
a search area setting unit configured to sequentially set each of a plurality of divisional frame areas as a search area, the divisional frame areas being obtained by dividing a screen frame into a plurality of areas;
an object searching unit configured to search an object included in the divisional frame area set as the search area, and detect a coordinate position of the searched object;
an object tracking unit configured to perform motion detection by comparing a previous screen frame with a current screen frame based on the coordinate position of the object searched by the object searching unit, and detect the coordinate position of the object in the current screen frame; and
a coordinate synthesizer configured to compare the coordinate position of the object searched by the object searching unit with the coordinate position of the object tracked by the object tracking unit, and specify the coordinate position of the object by cutting an overlapping coordinate position,
wherein the object searching unit searches the object included in divisional frame video data obtained by dividing the frame video data into a plurality of data blocks.

9. The video display device of claim 8,
wherein when the pair of overlapping coordinate positions is detected, the coordinate synthesizer cuts the coordinate position of the object tracked by the object tracking unit.

10. The video display device of claim 8,
wherein the coordinate synthesizer comprises:
an overlapping area detector configured to detect an overlapping area between two objects overlapping each other at least partially;
an area ratio judging unit configured to determine whether one object having a smaller area in the overlapping two objects occupies an area which is equal to or greater than a predetermined ratio of the overlapping area; and
an object cutting unit configured to cut the coordinate position of the object having the smaller area when the area ratio judging unit determines that the object having the smaller area occupies the area which is equal to or greater than the predetermined ratio.

11. The video display device of claim 8,
wherein the search area setting unit sets the divisional frame areas so that adjacent two divisional frame areas partially overlap each other.

12. The video display device of claim 8,
wherein processes performed by the object searching unit, the object tracking unit, and the coordinate synthesizer are repeated until the search area setting unit sets all of the divisional frame areas sequentially.

13. The video display device of claim 8,
wherein the object is a human face.

14. The video display device of claim 8, further comprising:
a depth information generator configured to generate depth information of the object having the coordinate position specified by the coordinate synthesizer; and
a three-dimensional data generator configured to generate parallax data for displaying the object in three dimension, based on the depth information generated by the depth information generator.

15. An object search method, comprising:
sequentially setting a plurality of divisional frame areas, the divisional frame areas being obtained by dividing a screen frame into a plurality of areas;
searching an object included in divisional frame video data corresponding to the set divisional frame area;
detecting a current coordinate position of the searched object based on previous frame video data and current frame video data; and
specifying the coordinate position of the object by cutting one of a pair of overlapping coordinate positions in the coordinate position of the searched object and the tracked coordinate position.

16. The method of claim 15,
wherein when the pair of overlapping coordinate positions is detected, the coordinate synthesizer cuts the coordinate position of the tracked object.

17. The method of claim 15,
wherein specifying the coordinate position comprises:
detecting an overlapping area between two objects overlapping each other at least partially;
determining whether one object having a smaller area in the overlapping two objects occupies an area which is equal to or greater than a predetermined ratio of the overlapping area; and
cutting the coordinate position of the object having the smaller area when it is determined that the object having the smaller area occupies the area which is equal to or greater than the predetermined ratio.

18. The method of claim 15,
wherein the divisional frame areas are set so that adjacent two divisional frame areas partially overlap each other.

19. The method of claim 15,
wherein searching the object, detecting the current coordinate position, and specifying the coordinate position are repeated until all of the divisional frame areas are set sequentially.

20. The method of claim 15, further comprising:
generating depth information of the object having the specified coordinate position; and
generating parallax data for displaying the object in three dimension, based on the generated depth information.
